(19) United States
(12) Patent Application Publication
(10) Pub. No.: US 2015/0262511 A1
(43) Pub. Date: Sep. 17, 2015

(54) SYSTEMS AND METHODS FOR MEDICAL DEVICE SIMULATOR SCORING

(71) Applicants: Henry Lin, Santa Clara, CA (US); Peter Dominick, Los Gatos, CA (US)

(72) Inventors: Henry Lin, Santa Clara, CA (US); Peter Dominick, Los Gatos, CA (US)

(21) Appl. No.: 14/660,641

(22) Filed: Mar. 17, 2015

Related U.S. Application Data
(60) Provisional application No. 61/954,277, filed on Mar. 17, 2014.
(60) Provisional application No. 62/029,957, filed on Jul. 28, 2014.

(51) Int. Cl. G09B 23/28

(52) U.S. Cl. CPC G09B 23/28

(57) ABSTRACT

A system for scoring a teleoperated surgical training session comprises a memory and a processor, the memory comprising instructions, which when executed by the processor, cause the processor to implement a computerized training module to: determine a performance efficiency component of the teleoperated surgical training session performed by a user; determine a penalty component of the teleoperated surgical training session; compute a training session score as a function of at least the performance efficiency component and the penalty component; and present the training session score to the user.

### CLAIM OF PRIORITY

This application claims the benefit of priority under 35 U.S.C. §119(e) to U.S. Provisional Patent Application Ser. No. 61/954,277, filed on Mar. 17, 2014 and U.S. Provisional Patent Application Ser. No. 62/029,957, filed on Jul. 28, 2014, both of which is incorporated by reference herein in their entireties.

### FIELD

Embodiments described herein generally relate to training and in particular, to systems and methods for medical device simulator scoring.

### BACKGROUND

Minimally invasive medical techniques are intended to reduce the amount of tissue that is damaged during diagnostic or surgical procedures, thereby reducing patient recovery time, discomfort, and deleterious side effects. Teleoperated surgical systems that use robotic technology (so-called surgical robotic systems) can be used to overcome limitations of manual laparoscopic and open surgery. Advances in telepresence systems provide surgeons views inside a patient's body, an increased number of degrees of motion of surgical instruments, and the ability for surgical collaboration over long distances. In view of the complexity of working with teleoperated surgical systems, proper and effective training is important.

### BRIEF DESCRIPTION OF THE DRAWINGS

In the drawings, which are not necessarily drawn to scale, like numerals describe similar components in different views. Like numerals having different letter suffixes may represent different instances of similar components. Some embodiments are illustrated by way of example, and not limitation, in the figures of the accompanying drawings in which:

FIG. 1 is a schematic drawing illustrating a teleoperated surgical system, according to an embodiment;

FIG. 2 is a block diagram illustrating a scoring methodology, according to an embodiment;

FIG. 3 is a drawing illustrating a user interface, according to an embodiment;

FIG. 4 is a drawing illustrating a user interface, according to an embodiment;

FIG. 5 is a flowchart illustrating a method of scoring a teleoperated surgical training session, according to an embodiment; and

FIG. 6 is a block diagram illustrating an example machine upon which any one or more of the techniques (e.g., methodologies) discussed herein can perform, according to an example embodiment.

### DESCRIPTION OF EMBODIMENTS

The following description is presented to enable any person skilled in the art to create and use systems and methods of a medical device simulator. Various modifications to the embodiments will be readily apparent to those skilled in the art, and the generic principles defined herein can be applied to other embodiments and applications without departing from the spirit and scope of the inventive subject matter. Moreover, in the following description, numerous details are set forth for the purpose of explanation. However, one of ordinary skill in the art will realize that the inventive subject matter might be practiced without the use of these specific details. In other instances, well-known machine components, processes and data structures are shown in block diagram form in order not to obscure the disclosure with unnecessary detail. Flow diagrams in drawings referenced below are used to represent processes. A computer system can be configured to perform some of these processes. Modules within flow diagrams representing computer implemented processes represent the configuration of a computer system according to computer program code to perform the acts described with reference to these modules. Thus, the inventive subject matter is not intended to be limited to the embodiments shown, but is to be accorded the widest scope consistent with the principles and features disclosed herein.

### Introduction

Surgical training can come in various forms, including observation, practice with cadavers or surgical training models, and simulation training. In the field of teleoperated surgery, all of these training techniques can be used. In order to provide a consistent and repeatable experience, simulation training can be preferred. A useful simulation learning experience should provide feedback to the user in three areas of performance—past, present, and future.

The past-performance feedback provides the user access to information such as personal historical scores and data, the user's learning curve relative to other measures such as an ideal learning curve, and analysis and feedback of the user's past performance.

The present-performance feedback provides the user access to information such as objective scores and metrics on the user's current attempt, comparison to peers and experts, comparison to personal averages or past performance, and analysis and feedback regarding the user's present attempt.

The future-performance feedback provides the user access to information such as what and how to improve, an adaptive curriculum that prepares the user for improved future performance, a projected learning path, and proficiency target predictions based on performance trends.

When analyzing performance for a teleoperated simulator, instructional objectives can be viewed on a continuum with basic system skills on one end of the continuum and robotic surgical procedures on the other end. In the middle, robotic surgical skills and tasks are represented. Thus a user can begin learning with basic robotic system skills, such as dexterous tasks like needle targeting, moving objects, or navigating instruments in space. Eventually, the user can progress to the middle of the continuum and practice robotic surgical skills, such as suturing or knot tying. After gaining proficiency in skills, the user can progress to robotic surgical procedures and procedural tasks, such as a hysterectomy.

Viewed another way, the basic robotic system skills focus on the system features (e.g., what the system is capable of doing) and the surgical procedures focus on the use of the system in various situations.

With a primary focus of promoting patient safety and a secondary focus of improving efficiency of task completion, the scoring system disclosed herein uses a paradigm of efficiencies and errors as two feedback metrics provided to users. The scoring and feedback mechanisms described herein do not make assessments regarding a user's surgical judgment or preferences. Instead, scoring and feedback include penalties for actions or inactions that could endanger patient safety.

### Teleoperated Surgical System

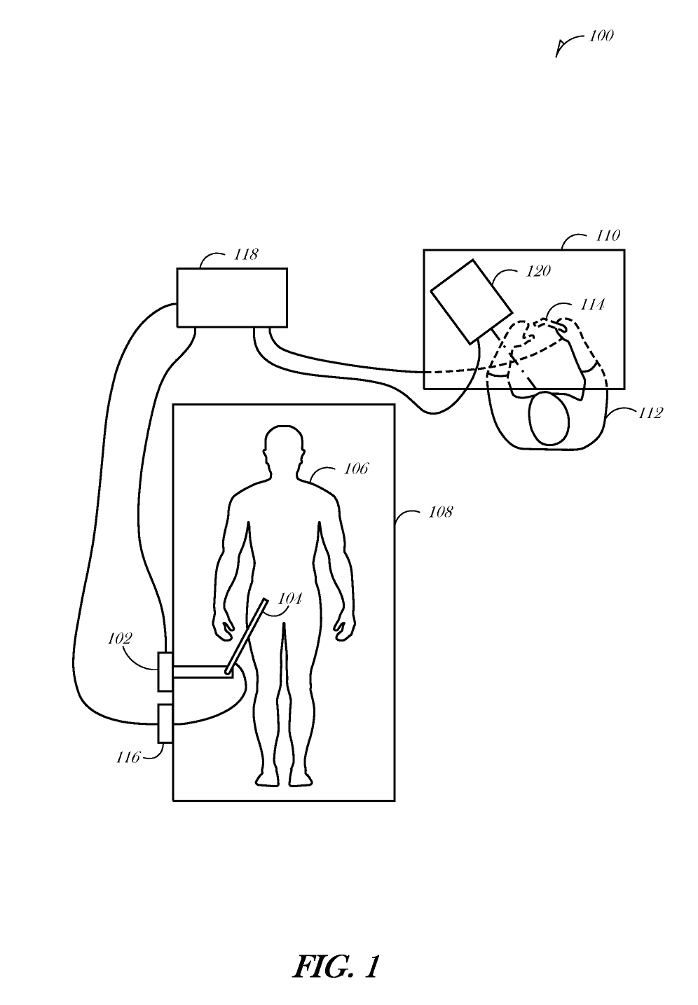

FIG. 1 is a schematic drawing illustrating a teleoperated surgical system 100, according to an embodiment. The teleoperated surgical system 100 includes a surgical manipulator assembly 102 for controlling operation of a surgical instrument 104 in performing various procedures on a patient 106. The surgical manipulator assembly 102 is mounted to or located near an operating table 108. A master assembly 110 allows a surgeon 112 to view the surgical site and to control the surgical manipulator assembly 102.

In alternative embodiments, the teleoperated surgical system 100 can include more than one surgical manipulator assembly 102. The exact number of manipulator assemblies will depend on the surgical procedure and the space constraints within the operating room among other factors.

The master assembly 110 can be located in the same room as the operating table 108. However, it should be understood that the surgeon 112 can be located in a different room or a completely different building from the patient 106. The master assembly 110 generally includes one or more control device(s) 114 for controlling the manipulator assembly 102. The control device(s) 114 can include any number of a variety of input devices, such as gravity-balanced arms, joysticks, trackballs, gloves, trigger grips, hand-operated controllers, hand motion sensors, voice recognition devices, eye motion sensors, or the like. In some embodiments, the control device(s) 114 can be provided with the same degrees of freedom as the associated surgical instruments 104 to provide the surgeon 112 with telepresence, or the perception that the control device(s) 114 are integral with the instrument 104 so that the surgeon 112 has a strong sense of directly controlling the instrument 104. In some embodiments, the control device 114 is a manual input device that moves with six degrees of freedom or more, and which can also include an actuatable handle or other control feature (e.g., one or more buttons, switches, etc.) for actuating instruments (for example, for closing grasping jaws, applying an electrical potential to an electrode, delivering a medicinal treatment, or the like).

A visualization system 116 provides a concurrent two- or three-dimensional video image of a surgical site to surgeon 112. The visualization system 116 can include a viewing scope assembly. In some embodiments, visual images can be captured by an endoscope positioned within the surgical site. The visualization system 116 can be implemented as hardware, firmware, software, or a combination thereof, and it interacts with or is otherwise executed by one or more computer processors, which can include the one or more processors of a control system 118.

A display system 120 can display a visual image of the surgical site and surgical instruments 104 captured by the visualization system 116. The display system 120 and the master control devices 114 can be oriented such that the relative positions of the visual imaging device in the scope assembly and the surgical instruments 104 are similar to the relative positions of the surgeon's eyes and hands so the operator (e.g., surgeon 112) can manipulate the surgical instrument 104 with the master control devices 114 as if viewing a working volume adjacent to the instrument 104 in substantially true presence. By “true presence” it is meant that the presentation of an image is a true perspective image simulating the viewpoint of an operator that is physically manipulating the surgical instruments 104.

The control system 118 includes at least one processor (not shown) and typically a plurality of processors for effecting control between the surgical manipulator assembly 102, the master assembly 114, and the display system 116. The control system 118 also includes software programming instructions to implement some or all of the methods described herein. While control system 118 is shown as a single block in the simplified schematic of FIG. 1, the control system 118 can comprise a number of data processing circuits (e.g., on the surgical manipulator assembly 102 and/or on the master assembly 110). Any of a wide variety of centralized or distributed data processing architectures can be employed. Similarly, the programming code can be implemented as a number of separate programs or subroutines, or it can be integrated into a number of other aspects of the teleoperated systems described herein. In various embodiments, the control system 118 can support wireless communication protocols, such as Bluetooth, IrDA, HomeRF, IEEE 802.11, DECT, and Wireless Telemetry.

In some embodiments, the control system 118 can include servo controllers to provide force and torque feedback from the surgical instrument 104 to the master assembly 114. Any suitable conventional or specialized servo controller can be used. A servo controller can be separate from, or integral with, the manipulator assembly 102. In some embodiments, the servo controller and the manipulator assembly 102 are provided as part of a robotic arm cart positioned adjacent to the patient 106. The servo controllers transmit signals instructing the manipulator assembly 102 to move the instrument 104, which extends into an internal surgical site within the patient body via openings in the body.

Each manipulator assembly 102 supports at least one surgical instrument 104 (e.g., “slave”) and can comprise a series of non-teleoperated, manually articulatable linkages and a teleoperated robotic manipulator. The linkages can be referred to as a set-up structure, which includes one or more links coupled with joints that allows the set-up structure to be positioned and held at a position and orientation in space. The manipulator assembly 102 can be driven by a series of actuators (e.g., motors). These motors actively move the robotic manipulators in response to commands from the control system 118. The motors are further coupled to the surgical instrument 104 so as to advance the surgical instrument 104 into a naturally or surgically created anatomical orifice and move the surgical instrument 104 in multiple degrees of freedom that can include three degrees of linear motion (e.g., X, Y, Z linear motion) and three degrees of rotational motion (e.g., roll, pitch, yaw). Additionally, the motors can be used to actuate an effector of the surgical instrument 104 such as an articulatable effector for grasping tissues in the jaws of a biopsy device or an effector for obtaining a tissue sample or for dispensing medicine, or another effector for providing other treatment as described more fully below. For example, the instrument 104 can be pitched and yawed around the remote center of motion, and it can be inserted and withdrawn through the remote center of motion (e.g., the z-axis motion). Other degrees of freedom can be provided by moving only part of the instrument (e.g., the end effector). For example, the end effector can be rolled by rolling the shaft, and the end effector is pitched and yawed at a distal-end wrist.

In an embodiment, the display system 120 can display a virtual environment simulating a surgical site within a patient. The virtual environment can include various biological structures in addition to the surgical instrument 104. The surgeon 112 operates the instrument 104 within the virtual environment to train, obtain certification, or experiment with various skills or procedures without having the possibility of harming a real patient.

### Overview of Scoring System

Disclosed herein is a scoring system that uses a data-driven approach. By leveraging a large data set of simulation surgical exercises, various weights are derived for each metric in a virtual surgical exercise. Some metrics are better differentiators of skill level and thus should have a larger weighting on a score. Also, some categories of metrics can be more indicative of proficiency than others. By using variable weights, a resultant score is based on these observations. The weight for a particular metric can be derived using a linear least squares non-negative constraint approach. Other estimation and regression methods can be used, including but not limited to linear regression, generalized linear model (GLM), nonlinear least squares, and nonlinear regression.

One goal is to obtain consistent scoring across various exercises. For novice users, training to reduce penalties is more important than training to increase efficiencies. That is, novices should first understand how to perform exercises with minimal errors. After doing so, then novice users may advance to increase efficiencies (e.g., reduce time to complete a procedure). Thus, as a user progresses, metrics describing efficiencies and penalties should improve reflecting the user's improved skill. By viewing the training spectrum along these axes (efficiencies and penalties), a user is provided more insight into an exercise's evaluation.

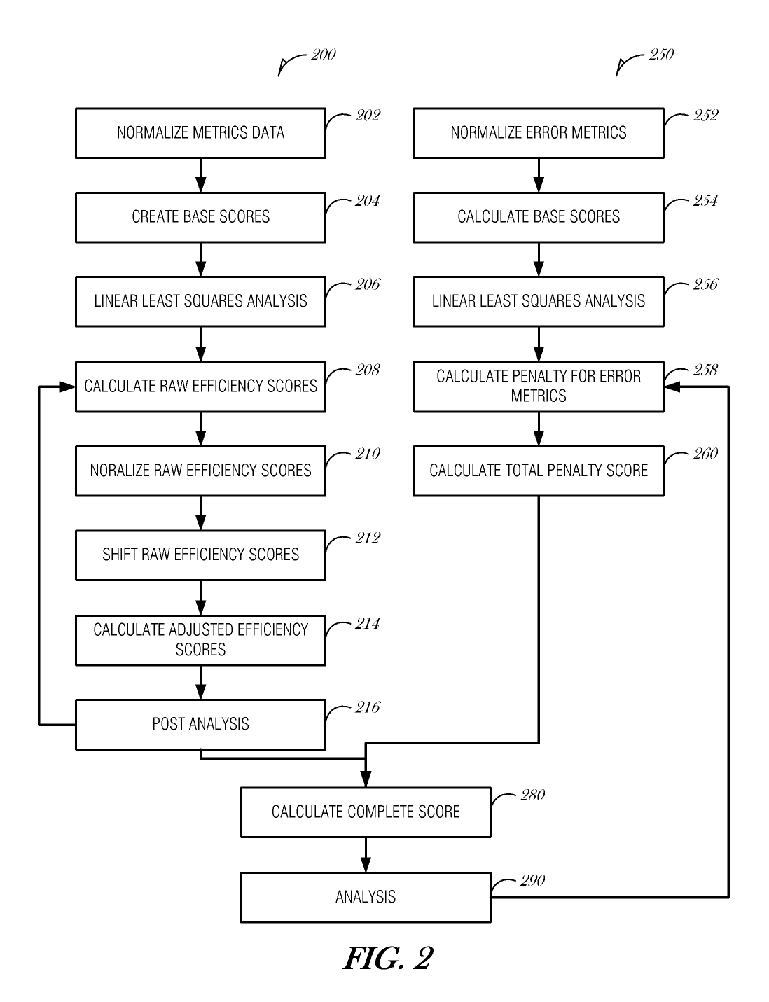

FIG. 2 is a block diagram illustrating a scoring methodology, according to an embodiment. There are two main phases illustrated in FIG. 2: an efficiency weight determination phase 200 and an error penalty determination phase 250. During the efficiency weight determination phase 200, metric data is normalized (block 202). Metrics can be normalized such that each metric is in a range from zero to one. To normalize metric data, for each metric, outlier data is removed from consideration, for example by removing the top and bottom of the range. In an embodiment, the top 5% and bottom 5% are considered outlier data and are removed. After removing outlier data, the minimum and maximum values are identified and the metric data is normalized with respect to the minimum and maximum values.

At block 204, baseline scores are determined. To do so, metrics for an exercise that have statistical significance when stratifying novices from experts are identified. Each metric can be given an equal weighting. A baseline score is determined for each data point by summing a linear combination of each weight (equal weight) multiplied by its corresponding normalized value (from block 202).

At block 206, a linear least squares analysis is performed on the baseline scores. A least squares system of equations can be set up, with three efficiency normalized metrics data on the left side and baseline scores on the right side. A least squares function with an additional non-negative construct can be used to determine weights for the baseline scores. Optionally, the weights are normalized.

At block 208, raw efficiency scores are calculated. The raw efficiency score for each data point can be determined by summing up each normalized efficiency weight multiplied by the data point's corresponding normalized metric value.

At block 210, the raw efficiency scores are normalized. The scores can be normalized to a range of zero to 100 in an embodiment. In this case, any raw efficiency scores that have a value over 100 can be set to 100 and any raw efficiency scores that have a value less than zero can be set to zero.

At block 212, the raw efficiency scores are shifted such that the resulting expert average is at a relatively high normalized value, such as 90. In an embodiment, the expert average is shifted to be between 92 and 94. An average raw efficiency score for an expert is computed. An adjustment value can then be calculated by subtracting the expert average from 95.

At block 214, an adjusted efficiency score is calculated. The adjusted efficiency score is adjusted by the adjustment value calculated in block 212. To maintain a range from zero to 100, the adjusted efficiency score can be set to 100 if it is over 100, and set to zero if it is less than zero.

At block 216, the adjusted efficiency scores are analyzed. The scores can be analyzed to determine if the learning curve, averages, or other characteristics of the adjusted efficiency scores are satisfactory. Some questions that can be used to determine satisfactory score distribution are whether the expert average scores are around 92 to 94, and whether there is satisfactory differentiation between novice scores and expert scores. If the score distribution is unsatisfactory, then operations in blocks 208-216 are repeated to determine a refined adjustment value. Otherwise, the adjusted efficiency scores are used as the final efficiency scores.

Turning to the error penalty determination phase 250, at block 252, error metrics are normalized. The top and bottom of the range can be removed, being considered outliner data. For example, the top 5% and the bottom 5% can be removed. After finding the minimum and maximum of the remaining data, the metrics data is normalized.

At block 254, the base penalty scores are calculated. Error metrics are given an equal weighting and a base penalty score for each data point is calculated by summing up a linear combination of each weight multiplied by its corresponding normalized value.

At block 256, the best fit penalty weights are determined using a least squares analysis. A least squares system of equations can be set up by having the penalty normalized metrics data on the left side and the corresponding base penalty scores on the right side. A least squares function with an additional non-negative constraint can be applied on the resulting weights. The output is the normalized penalty weights for each error metric. Percent penalty weights are calculated by dividing each normalized penalty weight by the sum of all normalized penalty weights. The sum of the percent penalty weights equals one.

At block 258, a penalty for each error metric is determined. Using the knowledge gained from the percent penalty weights and the average errors per metric for novices and experts, initial penalties for each instance of each error metric are determined. For each error metric, the average errors recorded by novices versus experts are analyzed. Based on this information and the percent penalty weights, a penalty for each unit of each error metric is subjectively determined.

At block 260, the total penalty is calculated. The total penalty is calculated from all error metrics. The total penalty for each error metric in each data point calculated by multiplying the number of errors for that metric in that data point by its corresponding error metric penalty. The total penalty is then calculated by summing up all of the total penalties for each of the error metrics.

At block 280, a complete score is calculated by subtracting the total penalty from the efficiency score.

At block 290, analysis can be used to determine if the learning curve, averages, etc. of the complete score are satisfactory. Whether the experts performances average out to a satisfactory score, or whether there is satisfactory differentiation between novices and experts can be analyzed. If the evaluator is not satisfied, then a refined total penalty can be recalculated (blocks 258-260).

### Working Example 1

The following is a working example of the scoring methodology illustrated in FIG. 2. In a simulated exercise, three efficiency metrics associated with an exercise are recorded: the time to complete (as a raw value), the economy of motion (as a raw value), and a master workspace range (as a raw value). The time to complete (T) is the time the user took to complete the exercise. The economy of motion (E) is the total distance the instruments traveled during the exercise. The economy of motion metric assumes that in order to minimize potential collisions with other instruments or cavity walls, a more experienced and proficient user will move the instruments less distance than a less experienced and proficient user during the exercise. The master workspace range (M) is calculated by determining the radius of the workspace of each instrument's three-dimensional workspace ellipsoid, and identifying the largest radius of the number of instruments in use. So, if there are three instruments, there are three radii, and the M is the largest of the three radii. When calculating the radius of operation of an instrument, in some embodiments, outliers are removed to determine a general operating radius (e.g., 20% of outliers are removed).

In an example simulation instance, a user obtains a T=259.12, E=292.59, and M=9.36. Given the raw inputs, these are normalized using minimum and maximum expected values. In this example, Tₘᵢₙ=87.00 and Tₘₐₓ=431.13; Eₘᵢₙ=152.53 and Eₘₐₓ=543.72; and Mₘᵢₙ=7.24 and Mₘₐₓ=13.62. With these minimums and maximums, the normalized values of T, E, and M are as follows:

$${T}_{norm} = \frac{T - {T}_{min}}{{T}_{max} - {T}_{min}} = \frac{172.12}{344.13} = 0.5002$$

$${E}_{norm} = \frac{E - {E}_{min}}{{E}_{max} - {E}_{min}} = \frac{140.03}{391.19} = 0.3580$$

$${M}_{norm} = \frac{M - {M}_{min}}{{M}_{max} - {M}_{min}} = \frac{2.12}{6.38} = 0.3323$$

To calculate the efficiency score, weights are obtained using a least squares analysis. In this example, the weights are found to be wt=0.0948 (weight for T), we=0.4239 (weight for E), and wm=0.1305 (weight for M). Additionally, an adjustment factor is identified as being af=1 and an adjustment value is identified as being av=5.84. To calculate the raw efficiency score, the normalized values of the time to complete metric (Tₙₒᵣₘ), economy of motion metric (Eₙₒᵣₘ), and master workspace range metric (Mₙₒᵣₘ) are computed in a weighted function.

$$\begin{matrix}rES 1 = \frac{( wt ) {T}_{norm} ) + ( we ) ( {E}_{norm} ) + ( wm ) ( {M}_{norm} )}{a f} - 1 & Formula 1 \\ rES 2 = ( - 100 ) * rES 1 & Formula 2 \\ Raw Efficiency Score = rES 2 + av & Formula 3\end{matrix}$$

If the raw efficiency score is less than zero, then the efficiency score is set to zero. If the raw efficiency score is greater than 100, then the efficiency score is set to 100. Otherwise, the efficiency score is set to the raw efficiency score.

In this case, the raw efficiency score is computed as follows:

$$rES 1 = \frac{( 0.0948 ) ( 0.5002 ) + ( 0.4239 ) ( 0.3580 ) + ( 0.1305 ) ( 0.3323 )}{1} - 1 = - 0.7575$$

$$rES 2 = - 100 * - 0.7575 = 75.75$$

$$Raw Efficiency Score = 75.75 + 5.84 = 81.59$$

Because the raw efficiency score is between 0 and 100, the efficiency score is set to the raw efficiency score, and Efficiency Score=81.59.

To compute the penalties, various error metrics are tracked, such as a number of times an object is dropped (e.g., a needle drop) or a number of times of excessive force applied. A list of penalty metrics is provided here, however it is understood that this list is not exhaustive and that other penalty metrics can be tracked and used.

D=drops

XF=excessive force

IC=instrument collisions

OOV=instrument(s) out of view

MT=missed target(s)

MET=misapplied energy time

BLV=blood loss volume

BV=broken vessels

Each metric can have an associated penalty weight. In an embodiment, the weights are determined using a linear least squares analysis (e.g., block 256 from FIG. 2). In another embodiment, arbitrary point deductions for each instance of a penalty metric are calculated. In such an embodiment, there is no need to normalize, because the weight is the points deducted per instance. The weight or point deduction is used to weight the associated penalty metric in a weighted function. For this example, the weights are as follows:

pd=2

pxf=0.3333

pic=2

poov=0.3333

pmt=0.3333

pmet=0.3333

pblv=0.3333

pbv=2

Assume that the user had the following penalty metrics during an exercise:

D=0

XF=1

IC=1

OOV=0.16

MT=6

MET=0

BLV=0

BV=0

In this case, the penalty for each error metric is:

Drops Penalty=pd*D=2*0=0

EF Penalty=pxf*XF=0.3333*1=0.3333

IC Penalty=pic*IC=2*1=2

OOV Penalty=poov*00V=0.3333*0.16=0.0533

MT Penalty=pmt*MT=0.3333*6=2

MET Penalty=pmet*MET=0.3333*0=0

BLV Penalty=pblv*BLV=0.3333*0=0

BV Penalty=pbv*BV=2*0=0

The total penalty is the sum of all of the individual penalties, which in this example is 4.39. The user's score for the exercise is then computed as the efficiency score minus the total penalty, which is 77.20.

It is understood that while this example includes three metrics (time to complete, economy of motion, and master workspace range), other examples can include more or fewer metrics. Also, while some examples of penalties are illustrated, it is understood that more or fewer penalties can be implemented.

### Working Example 2

In Working Example 1, the intention is to display the efficiency score as a single value—it was not designed to display the components of the efficient score to the user. Additionally, Working Example 1 calculated the raw efficiency score (rES1) as a function of the distance or performance away from the minimum “expert” value, which resulted in a negative points connotation.

In Working Example 2, the calculation for the raw efficiency score (rES1) is inverted. Instead of subtracting a value of “1” from the weighted combination of normalized components, each raw score is subtracted from “1” to identify a distance or performance away from the maximum “novice” value. In addition to providing a more intuitive score for users, Working Example 2 provides a mechanism to individually calculate (and display) each raw score and its contribution to the overall raw efficiency score.

The overall raw efficiency score is based on a scale from 0 to 100 points. Each completed exercise includes raw sub-scores, which when combined make the overall raw efficiency score. As with Working Example 1, the overall score is a result of the overall raw efficiency score minus the total penalty.

The efficiency score is based on a set of efficiency metrics that are unique to a given exercise. Some exercises also include an exercise constant, which provides a standard offset for the efficiency metrics. The user's combined performance on all of the efficiency metrics, including the exercise constant, forms the efficiency score. The efficiency score can be no higher than 100. In the general form:

Ts=Time to Complete Weighted Score=100(1−Tₙₒᵣₘ*af)wt Formula 4

Es=Economy of Motion Weighted Score=100(1−Eₙₒᵣₘ*af)we Formula 5

Ms=Master Workspace Range Weighted Score=100(1−Mₙₒᵣₘ*af)wm Formula 6

EC=Exercise Constant=100(af)(1−wt−we−wm) Formula 7:

rES1=(Ts+Es+Ms)+EC Formula 8

Raw Efficiency Score=rES1+av Formula 9

It is understood that while this example of a general form includes three metrics (time to complete, economy of motion, and master workspace range), other examples can include more or fewer metrics.

To earn points towards the efficiency score, a user's performance on each metric is first recorded and then compared to baseline values that represent a minimum and maximum range of acceptable performance. The performance is normalized within this range to ensure that it is scaled relatively to all other metrics. The normalized score is then converted to a point scale, which can be displayed to the user. The converted point scales can then be combined to determine the raw efficiency score rES1.

For demonstration, the normalized values of the time to complete metric (Tₙₒᵣₘ), economy of motion metric (Eₙₒᵣₘ), and master workspace range metric (Mₙₒᵣₘ) values from Working Example 1 are reused to illustrate Working Example 2. From Working Example 1, Tₙₒᵣₘ=0.5002, Eₙₒᵣₘ=0.3580, and Mₙₒᵣₘ=0.3323. To calculate the component scaled score for each, each normalized value is first subtracted from 1. In some cases, the normalized value is also be multiplied by an adjustment factor, af. Next, a weight is applied to each normalized value. The weight of each metric can vary from exercise to exercise, depending on the significance of the metric to the exercise. Finally, the result is multiplied by 100 to convert it into a point scale.

Scaled Value=(1−(Normalized Value*af))*weight*100 Formula 10:

So, for T, the scaled value Ts is (1−(0.5002*1))*0.0948*100=4.74. For E, the scaled value Es is (1−(0.3580*1))*0.4239*100=27.21. For M, the scaled value Ms is (1−(0.3323*1))*0.1305*100=8.71. The exercise constant EC is calculated as 100*af*(1−wt−we−wm)=100*1*(1−0.0948−0.4239−0.1305)=100*1*0.3508=35.08. The exercise constant captures the y-intercept of the best-fit line of the linear least squares analysis.

To calculate the raw efficiency score, the values for Ts, Es, Ms, and EC are added together along with the adjustment value av. So, Raw Efficiency Score=4.74+27.21+8.71+35.08+5.84=81.58, which is approximately the same value as found in Working Example 1 (81.59), off slightly due to rounding errors.

The penalty score is determined in the same manner as illustrated in Working Example 1. Thus, the overall score (raw efficiency score minus penalty score) in Working Example 2 is mathematically equivalent to the overall score from Working Example 1. This is illustrated through algebraic manipulation found here (assuming that the adjustment factor of is 1):

raw Efficiency Score (raw ES)=Ts+Es+Ms+EC+av (Formula 9)

raw ES=100(1−Tₙₒᵣₘ)wt+100(1−Eₙₒᵣₘ)we+100(1−Mₙₒᵣₘ)wm+100(1)(1−wt−we−wm)+av

raw ES=100(wt−wt*Tₙₒᵣₘ)+100(we−we*Eₙₒᵣₘ)+100(wm−wm*Mₙₒᵣₘ)+100(1−wt−we−wm)+av

raw ES=100(wt−wt*Tₙₒᵣₘ+we−we*Eₙₒᵣₘ+wm−wm*Mₙₒᵣₘ+1−wt−we−wm)+av

raw ES=100(−wt*Tₙₒᵣₘ−we*Eₙₒᵣₘ−wm*Mₙₒᵣₘ+1)+av

raw ES=−100(wt*Tₙₒᵣₘ+we*Eₙₒᵣₘ+wm*Mₙₒᵣₘ−1)+av (Formula 3)

Although there are differences in how the Efficiency Score is calculated in the implementation illustrated in Working Example 2 versus that illustrated in Working Example 1, the 0-100 Overall Score and the 0-100 Efficiency Score remain the same in both calculations.

In Working Example 1, each efficiency metric represents the distance off the minimum “expert” values. This led to several aspects about the calculation:
1. The efficiency metric points captured the distance or performance off the minimum “expert” values, which resulted in a negative points connotation.
2. The sum of the weights of the Efficiency metrics do not sum to 100%. This is inherent in the linear least squares calculation, as it finds the best fit. The remaining “weight” or the (1-sum of efficiency weights) can be loosely viewed as the y-intercept of the best fit line.
3. The adjustment factor and adjustment values were used to standardize the expert mean of each exercise to fall between 91-94. This would be more difficult to explain in relation to negative efficiency component values.

In order to display information about each Efficiency component in an intuitive way to the user, the calculation is inverted in Working Example 2 in order to produce easy to understand efficiency components points. Aspects of Working Example 2 include:
1. The efficiency metric points reflect the distance off the maximum “novice” values. This is more intuitive, as users naturally progressed from maximum “novice” values to minimum “expert” values (for efficiency metrics). This also results in positive values.
2. The sum of the remaining weights and adjustment values is represented as the exercise constant. The exercise constant can be characterized as the score that someone achieves when they achieve the maximum novice values for each of the efficiency metrics (e.g., the efficiency components each resulted in 0 points).

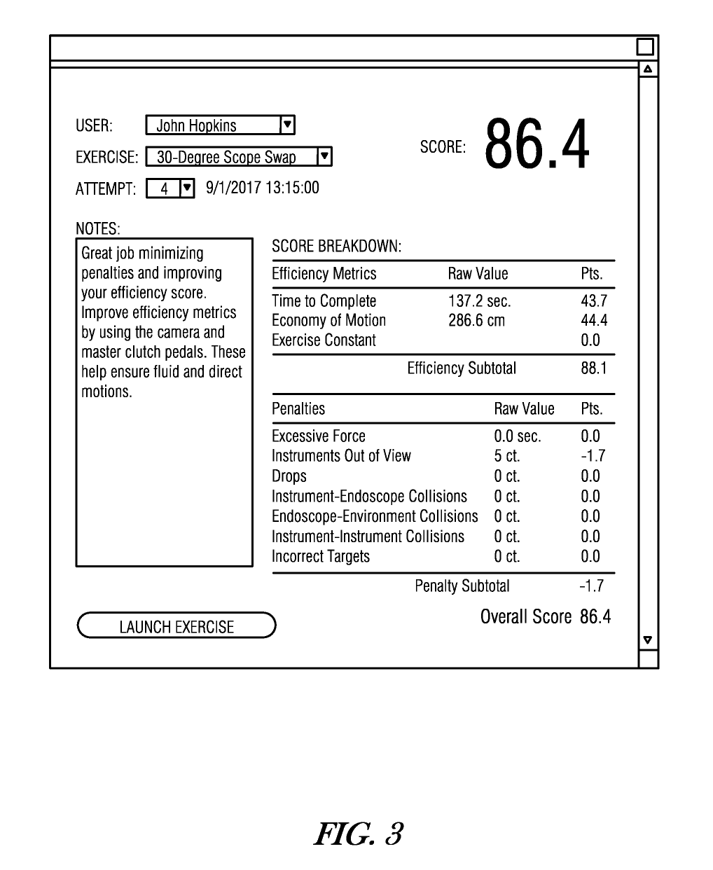

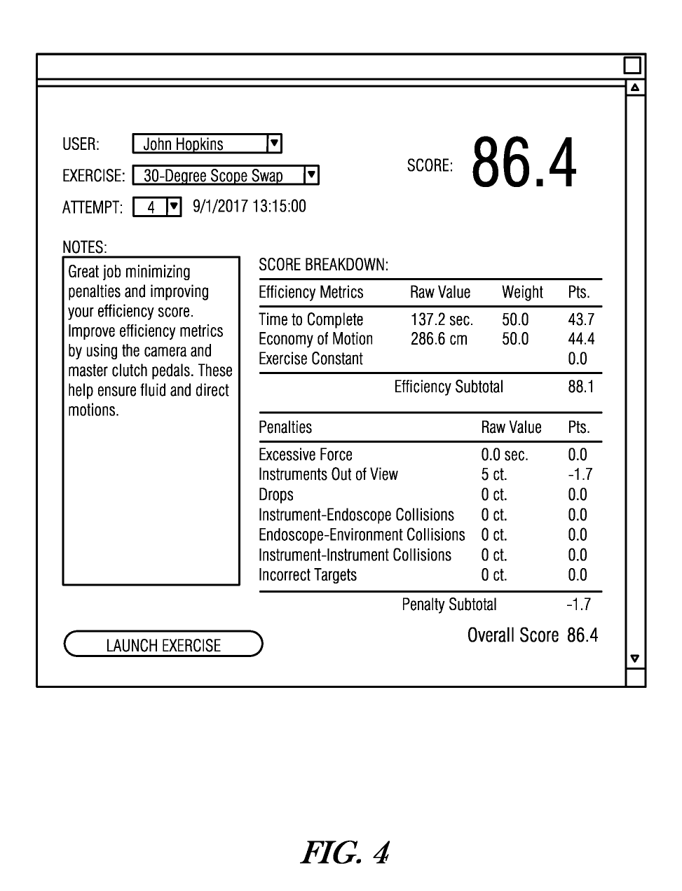

For example, FIG. 3 shows a user achieving 43.7 points for Time to Complete and 44.4 points for Economy of Motion. The weights for the two metrics are each 50% (not shown), and the exercise constant is 0. That means that had the user achieved 50 points for each metric, he would have performed at the minimum value level (e.g., fast time to complete or efficient motion measured by less overall movement), or the “expert” level. His achievement of 43.7 and 44.4 shows that he performed slightly below expert level, resulting in an Efficiency Score of 88.1. Another embodiment of the user interface with the weights displayed is shown in FIG. 4.

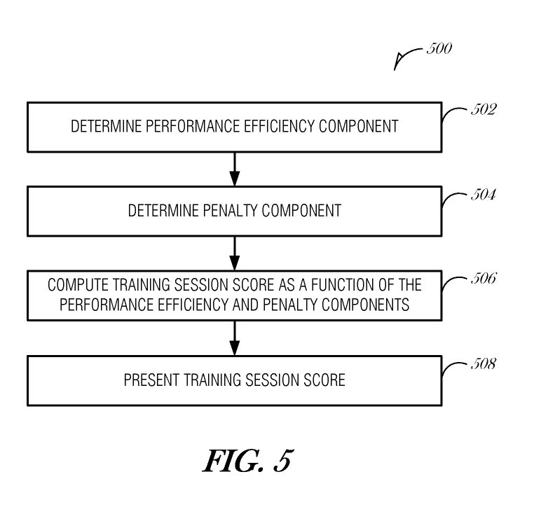

FIG. 5 is a flowchart illustrating a method 500 of scoring a teleoperated surgical training session, according to an embodiment. At block 502, a performance efficiency component of the teleoperated surgical training session performed by a user is determined by a computerized training module.

In an embodiment, determining the performance efficiency component comprises accessing a plurality of raw metric values of performance efficiency, the raw metric values obtained during the performance of the teleoperated surgical training session performed by the user; normalizing the raw metric values to provide normalized raw metric values; and calculating the performance efficiency component as a function of the normalized raw metric values. For example, the performance efficiency component can be calculated as illustrated above in Working Example 1 or Working Example 2. In a further embodiment, calculating the performance efficiency component comprises weighting the normalized raw metric values in a linear combination. In a further embodiment, weights used in the linear combination are assigned to a respective plurality of performance metrics, wherein the plurality of performance metrics is related to the performance efficiency component. In a further embodiment, the plurality of performance metrics comprise a time to complete the teleoperated surgical training session, an economy of motion during the teleoperated surgical training session, and a master workspace range observed during the teleoperated surgical training session.

In an embodiment, the weights used in the linear combination are calculated by: normalizing metrics data of a training population; creating a baseline performance efficiency score; and calculating the weights using a least squares analysis. In an embodiment, the least squares analysis comprises a least squares non negative analysis. In a further embodiment, normalizing metrics data of the training population comprises: identifying the metrics data of the training population; removing outliers from the training population to produce a remaining population; and normalizing the remaining population to produce normalized metrics.

In a further embodiment, creating the baseline training session score comprises: receiving the normalized metrics; and calculating the baseline performance efficiency score by summing a linear combination of the normalized metrics.

In an embodiment, the method 500 includes applying an equal weight to each of the normalized metrics; and wherein calculating the baseline performance efficiency score comprises summing a linear combination of the normalized metrics multiplied by the equal weight.

At block 504, a penalty component of the teleoperated surgical training session is determined. In an embodiment, determining the penalty component comprises: accessing a plurality of raw metric values of performance errors, the raw metric values obtained during the performance of the teleoperated surgical training session performed by the user; normalizing the raw metric values to provide normalized raw metric values; and calculating the penalty component as a function of the normalized raw metric values. In a further embodiment, calculating the penalty component comprises: weighting the normalized raw metric values in a linear combination.

In an embodiment, the weights used in the linear combination are calculated by: normalizing metrics data of a training population; creating a baseline penalty score; and calculating the plurality of weights using a least squares analysis. In an embodiment, least squares analysis comprises a least squares non negative analysis.

In a further embodiment, normalizing metrics data of the training population comprises: identifying the metrics data of the training population; removing outliers from the training population to produce a remaining population; and normalizing the remaining population to produce normalized metrics. In a further embodiment, creating the baseline penalty score comprises: receiving the normalized metrics; and calculating the baseline penalty score by summing a linear combination of the normalized metrics. In a further embodiment, the method 500 includes applying an equal weight to each of the normalized metrics; and wherein the calculating the baseline penalty score comprises summing a linear combination of the normalized metrics multiplied by the equal weight.

At block 506, a training session score is computed as a function of at least the performance efficiency component and the penalty component. The training session score can be calculated by subtracting the penalty component from the performance efficiency component.

At block 508, the training session score is presented to the user. The training session score can be presented in a user interface that is viewed within the simulator. Efficiencies and/or penalties can be provided as raw numbers, normalized values, component values (e.g., each penalty score), or aggregated values.

In an embodiment, the method 500 includes determining by the computerized training module, a mental component of the teleoperated surgical training session; and determining by the computerized training module, a physiological component of the teleoperated surgical training session; wherein computing the training session score comprises computing the training session score as a function of at least the mental component and the physiological component.

In an embodiment, the method 500 includes, wherein the teleoperated surgical training session comprises one of a plurality of skill-based sessions. Skill-based sessions can include, but are not limited to, skills selected from the group consisting of two-handed transfer, pick and place, wrist manipulation, camera control, clutch control, three arm usage, needle control, energy use. In a further embodiment, the method 500 includes computing an experience score for a skill-based session performed by the user during the teleoperated surgical training session; aggregating the experience score to calculate a historical experience score of the user for the skill-based session; and determining whether the historical experience score exceeds a proficiency threshold. In a further embodiment, the method 500 includes presenting an indication to the user that the historical experience score exceeds the proficiency threshold. In another embodiment, the method 500 includes presenting the historical experience score to the user.

In an embodiment, the method 500 includes identifying a curriculum for the user, the curriculum including at least one skill-based session and designed to assist the user in gaining proficiency with a skill associated with the at least one skill-based session; and presenting the curriculum to the user. In a further embodiment, the curriculum is designed to provide the user with skills to pass a proficiency standard.

### Computer Hardware and Storage Devices

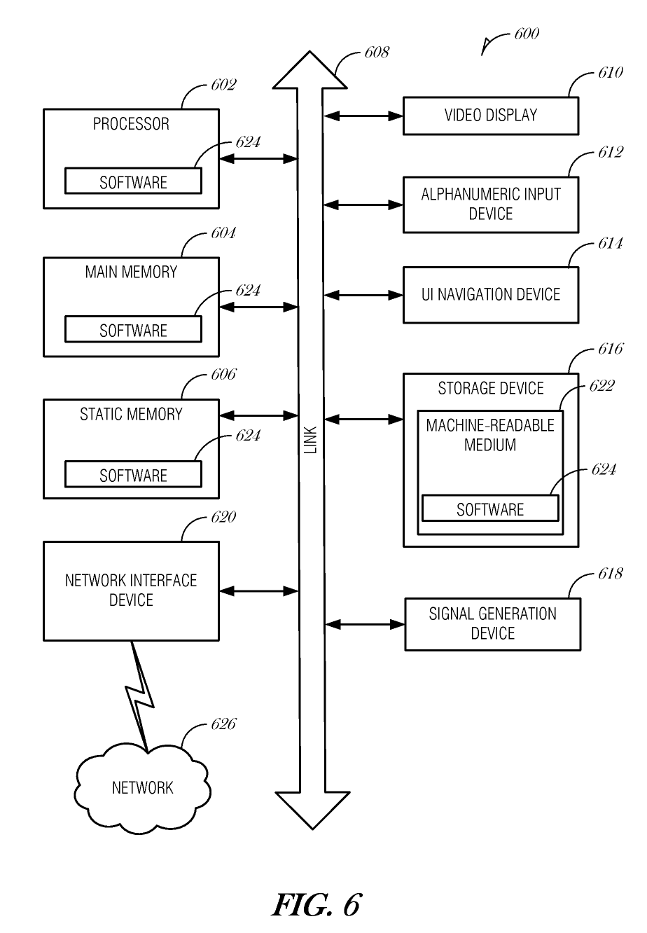

FIG. 6 is a block diagram illustrating an example machine upon which any one or more of the techniques (e.g., methodologies) discussed herein can perform, according to an example embodiment. FIG. 6 shows an illustrative diagrammatic representation of a more particularized computer system 600. The computer system 600 can be configured to implement, for example, a computerized training module. In alternative embodiments, the computer system 600 operates as a standalone device or can be connected (e.g., networked) to other machines. In a networked deployment, the computer system 600 can operate in the capacity of a server or a client machine in server-client network environment, or as a peer machine in a peer-to-peer (or distributed) network environment. The computer system 600 can be a server computer, a client computer, a personal computer (PC), a tablet PC, a Personal Digital Assistant (PDA), a cellular telephone, a web appliance, a network router, switch or bridge, or any machine capable of executing a set of instructions (sequential or otherwise) that specify actions to be taken by that machine. Further, while only a single machine (i.e., computer system 600) is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU), or both), a main memory 604 and a static memory 606, which communicate with each other via a bus 608. The computer system 600 can further include a video display unit 610 (e.g., liquid crystal display (LCD), organic light emitting diode (OLED) display, touch screen, or a cathode ray tube (CRT)) that can be used to display positions of the surgical instrument 104 and flexible instrument 120, for example. The computer system 600 also includes an alphanumeric input device 612 (e.g., a keyboard, a physical keyboard, a virtual keyboard using software), a cursor control device or input sensor 614 (e.g., a mouse, a track pad, a trackball, a sensor or reader, a machine readable information reader, bar code reader), a disk drive unit 616, a signal generation device 618 (e.g., a speaker) and a network interface device or transceiver 620.

The disk drive unit 616 includes a non-transitory machine-readable storage device medium 622 on which is stored one or more sets of instructions 624 (e.g., software) embodying any one or more of the methodologies or functions described herein. The instructions 624 can also reside, completely or at least partially, within the main memory 604, static memory 606 and/or within the processor 602 during execution thereof by the computer system 600, the main memory 604 and the processor 602 also constituting non-transitory machine-readable storage device media. The non-transitory machine-readable storage device medium 622 also can store an integrated circuit design and waveform structures. The instructions 624 can further be transmitted or received over a network 626 via the network interface device or transceiver 620.

While the machine-readable storage device medium 622 is shown in an example embodiment to be a single medium, the term “machine-readable medium,” “computer readable medium,” and the like should be taken to include a single medium or multiple media (e.g., a centralized or distributed database, and/or associated caches and servers) that store the one or more sets of instructions 624. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to, solid-state memories, optical and magnetic media, and carrier wave signals.

It will be appreciated that, for clarity purposes, the above description describes some embodiments with reference to different functional units or processors. However, it will be apparent that any suitable distribution of functionality between different functional units, processors or domains can be used without detracting from the present disclosure. For example, functionality illustrated to be performed by separate processors or controllers can be performed by the same processor or controller. Hence, references to specific functional units are only to be seen as references to suitable means for providing the described functionality, rather than indicative of a strict logical or physical structure or organization.

Although the present disclosure has been described in connection with some embodiments, it is not intended to be limited to the specific form set forth herein. One skilled in the art would recognize that various features of the described embodiments can be combined in accordance with the present disclosure. Moreover, it will be appreciated that various modifications and alterations can be made by those skilled in the art without departing from the spirit and scope of the present disclosure.

In addition, in the foregoing detailed description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the detailed description, with each claim standing on its own as a separate embodiment.

The foregoing description and drawings of embodiments in accordance with the present invention are merely illustrative of the principles of the inventive subject matter. Therefore, it will be understood that various modifications can be made to the embodiments by those skilled in the art without departing from the spirit and scope of the inventive subject matter, which is defined in the appended claims.

Thus, while certain exemplary embodiments of the invention have been described and shown in the accompanying drawings, it is to be understood that such embodiments are merely illustrative of and not restrictive on the broad inventive subject matter, and that the embodiments of the invention not be limited to the specific constructions and arrangements shown and described, since various other modifications can occur to those ordinarily skilled in the art.

What is claimed is:

1. A method of scoring a teleoperated surgical training session, the method comprising:
determining by a computerized training module, a performance efficiency component of the teleoperated surgical training session performed by a user;
determining by the computerized training module, a penalty component of the teleoperated surgical training session;
computing by the computerized training module, a training session score as a function of at least the performance efficiency component and the penalty component; and
presenting the training session score to the user.

2. The method of claim 1, wherein determining the performance efficiency component comprises:
accessing a plurality of raw metric values of performance efficiency, the raw metric values obtained during the performance of the teleoperated surgical training session performed by the user;
normalizing the raw metric values to provide normalized raw metric values; and
calculating the performance efficiency component as a function of the normalized raw metric values.

3. The method of claim 2, wherein calculating the performance efficiency component comprises:
weighting the normalized raw metric values in a linear combination.

4. The method of claim 3, wherein weights used in the linear combination are assigned to a respective plurality of performance metrics, wherein the plurality of performance metrics is related to the performance efficiency component.

5. The method of claim 4, wherein the plurality of performance metrics comprise a time to complete the teleoperated surgical training session, an economy of motion during the teleoperated surgical training session, and a master workspace range observed during the teleoperated surgical training session.

6. The method of claim 1, wherein determining the penalty component comprises:
accessing a plurality of raw metric values of performance errors, the raw metric values obtained during the performance of the teleoperated surgical training session performed by the user;
normalizing the raw metric values to provide normalized raw metric values; and
calculating the penalty component as a function of the normalized raw metric values.

7. The method of claim 1, comprising:
determining by the computerized training module, a mental component of the teleoperated surgical training session; and
determining by the computerized training module, a physiological component of the teleoperated surgical training session;
wherein computing the training session score comprises computing the training session score as a function of at least the mental component and the physiological component.

8. The method of claim 1, wherein the teleoperated surgical training session comprises one of a plurality of skill-based sessions selected from the group consisting of two-handed transfer, pick and place, wrist manipulation, camera control, clutch control, three arm usage, needle control, energy use.

9. The method of claim 8, comprising:
computing an experience score for a skill-based session performed by the user during the teleoperated surgical training session;
aggregating the experience score to calculate a historical experience score of the user for the skill-based session; and
determining whether the historical experience score exceeds a proficiency threshold.

10. The method of claim 9, comprising:
presenting an indication to the user that the historical experience score exceeds the proficiency threshold.

11. A system for scoring a teleoperated surgical training session, the system comprising:
a memory and a processor, the memory comprising instructions, which when executed by the processor, cause the processor to implement a computerized training module to:
determine a performance efficiency component of the teleoperated surgical training session performed by a user;
determine a penalty component of the teleoperated surgical training session;
compute a training session score as a function of at least the performance efficiency component and the penalty component; and
present the training session score to the user.

12. The system of claim 11, wherein to determine the performance efficiency component, the computerized training module is to:
access a plurality of raw metric values of performance efficiency, the raw metric values obtained during the performance of the teleoperated surgical training session performed by the user;
normalize the raw metric values to provide normalized raw metric values; and
calculate the performance efficiency component as a function of the normalized raw metric values.

13. The system of claim 11, wherein to determine the penalty component, the computerized training module is to:
access a plurality of raw metric values of performance errors, the raw metric values obtained during the performance of the teleoperated surgical training session performed by the user;
normalize the raw metric values to provide normalized raw metric values; and
calculate the penalty component as a function of the normalized raw metric values.

14. The system of claim 13, wherein to calculate the penalty component, the computerized training module is to:
weight the normalized raw metric values in a linear combination.

15. The system of claim 14, wherein the weights used in the linear combination are calculated by:
normalizing metrics data of a training population;
creating a baseline penalty score; and
calculating the plurality of weights using a least squares analysis.

16. The system of claim 15, wherein to normalize metrics data of the training population, the computerized training module is to:
identify the metrics data of the training population;
remove outliers from the training population to produce a remaining population; and
normalize the remaining population to produce normalized metrics.

17. A computer-readable medium comprising instructions, which when executed by a computer, cause the computer to:
determine a performance efficiency component of the teleoperated surgical training session performed by a user;
determine a penalty component of the teleoperated surgical training session;
compute a training session score as a function of at least the performance efficiency component and the penalty component; and
present the training session score to the user.

18. The computer-readable medium of claim 17, wherein the instructions to determine the performance efficiency component comprise instructions to:
access a plurality of raw metric values of performance efficiency, the raw metric values obtained during the performance of the teleoperated surgical training session performed by the user;
normalize the raw metric values to provide normalized raw metric values; and
calculate the performance efficiency component as a function of the normalized raw metric values.

19. The computer-readable medium of claim 17, wherein the teleoperated surgical training session comprises one of a plurality of skill-based sessions selected from the group consisting of two-handed transfer, pick and place, wrist manipulation, camera control, clutch control, three arm usage, needle control, energy use.

20. The computer-readable medium of claim 19, comprising instructions to:
compute an experience score for a skill-based session performed by the user during the teleoperated surgical training session;
aggregate the experience score to calculate a historical experience score of the user for the skill-based session; and
determine whether the historical experience score exceeds a proficiency threshold.
